(19) United States
(12) Patent Application Publication
(10) Pub. No.: US 2022/0224167 A1
(43) Pub. Date: Jul. 14, 2022

(54) MAGNETIC SHIELDING SHEET FOR CHARGING CRADLE, WIRELESS POWER RECEPTION MODULE FOR CHARGING CRADLE, AND CHARGING CRADLE FOR WIRELESS EARPHONES INCLUDING THE SAME

(71) Applicant: AMOSENSE CO.,LTD., Cheonan-si Chungcheongnam-do (KR)

(72) Inventor: Kil Jae JANG, Cheonan-si Chungcheongnam-do (KR)

(73) Assignee: AMOSENSE CO.,LTD., Cheonan-si Chungcheongnam-do (KR)

(21) Appl. No.: 17/610,205

(22) PCT Filed: Jun. 25, 2020
(86) PCT No.: PCT/KR2020/008266

§ 371 Date: Nov. 10, 2021

(30) Foreign Application Priority Data
Jun. 26, 2019 (KR) 10-2019-0076435
Jun. 25, 2020 (KR) 10-2020-0077594

(51) Int. Cl. H02J 50/70; H02J 50/10; H01F 27/36; H02J 50/00; H02J 7/00; H04R 1/10

(52) U.S. Cl. CPC H02J 50/70; H02J 50/10; H01F 27/36; H02J 50/005; H04R 2420/07; H04R 1/1041; H04R 1/1016; H04R 1/1025; H02J 7/0044

(57) ABSTRACT

Provided are a magnetic shielding sheet for a charging cradle and a wireless power reception module for a charging cradle and a charging cradle for wireless earphones including the same. A magnetic shielding sheet for a charging cradle according to an exemplary embodiment of the present invention includes a sheet body formed of a magnetic material to shield a magnetic field, wherein the sheet body is formed of a magnetic material having a saturation magnetic flux density of 1.2 Tesla or more.

### CROSS REFERENCE TO RELATED APPLICATIONS

This application is the national phase entry of International Application No. PCT/KR2020/008266, filed on Jun. 25, 2020, which is based upon and claims priority to Korean Patent Application 10-2019-0076435, filed on Jun. 26, 2019 and Korean Patent Application 10-2020-0077594, filed on Jun. 25, 2020, the entire contents of which are incorporated herein by reference.

### TECHNICAL FIELD

The present invention is directed to providing a magnetic shielding sheet for a charging cradle, a wireless power reception module for a charging cradle including the magnetic shielding sheet, and a charging cradle for a wireless earphone including the magnetic shielding sheet.

### BACKGROUND

Recently, battery charging technologies using wireless charging are being applied to wearable devices, such as smartwatches, or wireless earphones such as Bluetooth earphones.

As an example, a battery of a wearable device or wireless earphone may be charged with power provided from a charging cradle while mounted on the charging cradle.

Meanwhile, a battery built in the charging cradle for charging a battery of a wearable device or a wireless earphone is also charged in a wireless charging manner.

To this end, a wireless power reception module capable of receiving wireless power from an external device is built in the charging cradle. Accordingly, a user may simply charge a battery of a smartwatch or wireless earphone using the charging cradle in a state in which a battery of the charging cradle is charged in a wireless manner.

Such a charging cradle generally includes a built-in permanent magnet to fix a smartwatch or wireless earphone or fix a relative position between components, and the permanent magnet generates an intensive direct current magnetic field.

Accordingly, the direct current magnetic field generated by the permanent magnet affects the performance of a magnetic shielding sheet constituting the wireless power reception module. That is, since the direct current magnetic field generated by the permanent magnet affects the performance of the magnetic shielding sheet, wireless charging efficiency is reduced.

Accordingly, the charging cradle including the built-in permanent magnet has a problem of not satisfying properties required for Qi certification.

Accordingly, a measure for not only preventing the reduction of the wireless charging efficiency but also solving a Qi certification issue is required even if the permanent magnet is built in the charging cradle.

### SUMMARY OF THE INVENTION

The inventors of the present invention found that a saturation magnetic flux of a magnetic material constituting a magnetic shielding sheet greatly affects wireless charging efficiency and a Qi certification issue and thus completed the present invention as a result of repeated intensive research and experiments.

That is, it was learned through the repeated research and experiments, when a magnetic shielding sheet is formed of a magnetic material having a predetermined saturation magnetic flux or more, for example, 1.2 Tesla or more and a magnetic permeability of 400 or more, magnetic saturation due to a direct current magnetic field generated by a permanent magnet is prevented, and a required inductance value may be stably satisfied.

The present invention is directed to providing a magnetic shielding sheet, which is capable satisfying a required inductance value and solving a Qi certification issue even when a permanent magnet is employed in a charging cradle, for a charging cradle, a wireless power reception module for a charging cradle including the magnetic shielding sheet, and a charging cradle for a wireless earphone including the magnetic shielding sheet.

One aspect of the present invention provides a magnetic shielding sheet for a charging cradle in which at least one permanent magnet is built, the magnetic shielding sheet comprising a sheet body formed of a magnetic material to shield a magnetic field, wherein the sheet body is formed of a magnetic material having a saturation magnetic flux of 1.2 Tesla or more.

The sheet body may be a heat-treated amorphous ribbon sheet and may have a magnetic permeability of 400 or more.

As an example, the amorphous ribbon sheet may be a ribbon sheet including Fe, Si, and B and may be a multi-layer sheet stacked as two layers to ten layers.

As another example, the amorphous ribbon sheet may be a ribbon sheet including Fe, Si, and Nb and may be a multi-layer sheet stacked as ten layers to thirty layers. In addition, the amorphous ribbon sheet may be formed separately into a plurality of pieces, and the amorphous ribbon sheet may have a magnetic permeability of 400 or more in a state in which the amorphous ribbon sheet is formed separately into the plurality of pieces.

In addition, the sheet body may have a magnetic permeability ranging from 600 to 1200.

Meanwhile, another aspect of the present invention provides a wireless power reception module for a charging cradle, which is applied to the charging cradle in which at least one permanent magnet is built, the wireless power reception module comprising a wireless power reception antenna configured to receive wireless power, and a magnetic shielding sheet disposed on one surface of the wireless power reception antenna to shield a magnetic field, wherein the magnetic shielding sheet may be the above-described magnetic shielding sheet for a charging cradle.

The wireless power reception antenna may be a flat coil in which a conductive member having a predetermined diameter is wound in one direction.

Meanwhile, still another aspect of the present invention provides a charging cradle for a wireless earphone comprising a case in which an accommodation part for accommodating a wireless earphone is formed, a cover coupled to the case to cover an open upper portion of the accommodation part, at least one permanent magnet provided on at least any one side of the case and the cover, a circuit board which is built in the case and is configured to control an overall operation, a magnetic shielding sheet disposed under the circuit board to shield a magnetic field, and a wireless power reception antenna disposed on one surface of the magnetic shielding sheet to receive wireless power, wherein the magnetic shielding sheet may be the above-described magnetic shielding sheet for a charging cradle.

According to the present invention, since a magnetic shielding sheet is formed of a magnetic material having a saturation magnetic flux of 1.2 Tesla or more and a magnetic permeability of 400 or more, even when a charging cradle employs a permanent magnet, performance degradation due to a direct current magnetic field of the permanent magnet can be prevented, and all quality certification issues can be solved.

### BRIEF DESCRIPTION OF THE DRAWINGS

FIG. 1 is a cross-sectional view illustrating a magnetic shielding sheet for a charging cradle according to one embodiment of the present invention.

FIG. 2 is a schematic view illustrating a wireless power reception module for a charging cradle using the magnetic shielding sheet for a charging cradle according to one embodiment of the present invention.

FIG. 3 is a schematic view illustrating a charging cradle, to which the magnetic shielding sheet for a charging cradle according to one embodiment of the present invention is applicable, for a wireless earphone.

FIG. 4 is an exploded view illustrating the charging cradle for a wireless earphone of FIG. 3.

FIG. 5 is a vertical cross-sectional view illustrating a state in which a cover covers an accommodation part of a case in FIG. 3.

### DETAILED DESCRIPTION

Hereinafter, embodiments of the present invention will be described in detail with reference to the accompanying drawings in order for those skilled in the art to easily perform the present invention. The present invention may be implemented in several different forms and is not limited to the embodiments described herein. Parts irrelevant to descriptions are omitted in the drawings in order to clearly explain the present invention, and the same or similar parts are denoted by the same reference numerals throughout this specification.

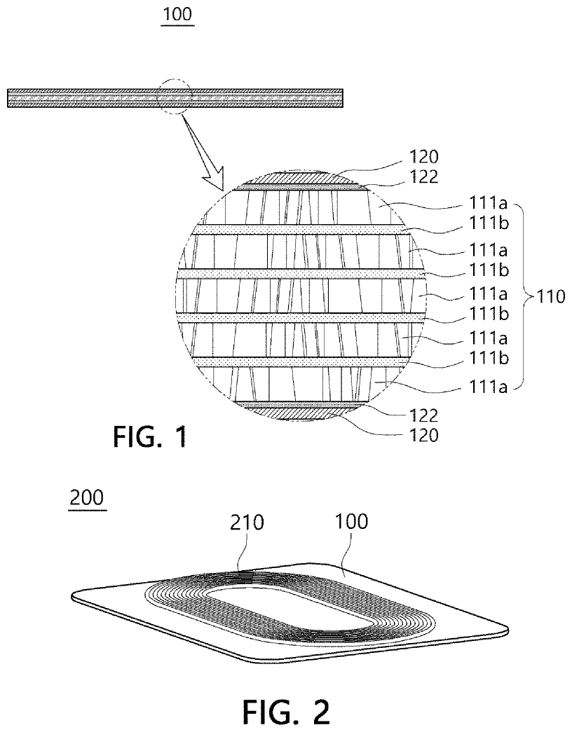

A magnetic shielding sheet 100 for a charging cradle according to one embodiment of the present invention includes a sheet body 110 as illustrated in FIG. 1.

The sheet body 110 may shield a magnetic field generated by an antenna used for wireless power transfer or wireless charging and collect the magnetic field in a desired direction.

Here, as illustrated in FIG. 2, the antenna may be a wireless power reception antenna 210 for constituting a wireless power reception module 200 which will be described below.

The sheet body 110 may be formed of a magnetic material and may be a plate-shaped sheet having a predetermined area.

In this case, the sheet body 110 may be formed of the magnetic material having a saturation magnetic flux of 1.2 Tesla or more, and preferably, the sheet body 110 may be formed of a magnetic material having a saturation magnetic flux of 1.2 Tesla or more and a magnetic permeability of 400 or more.

As a non-restrictive example, the sheet body 110 may include amorphous ribbon sheets 111a, and the amorphous ribbon sheets 111a may be ribbon sheets including Fe, Si, and B or ribbon sheets including Fe, Si, and Nb.

In addition, the sheet body 110 may be also a ribbon sheet including Fe, Si, B, Cu, and Nb.

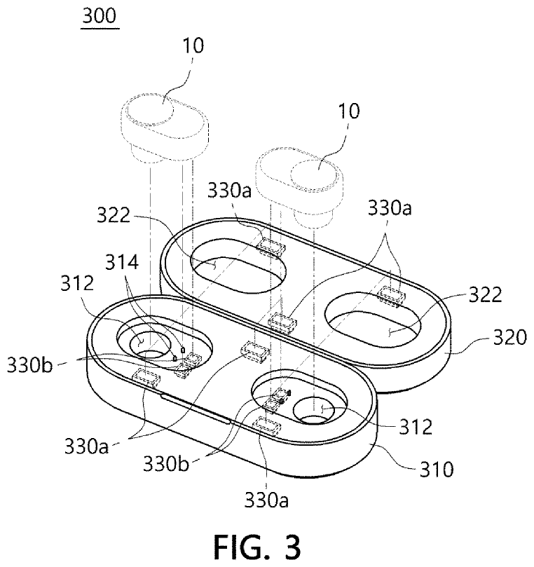

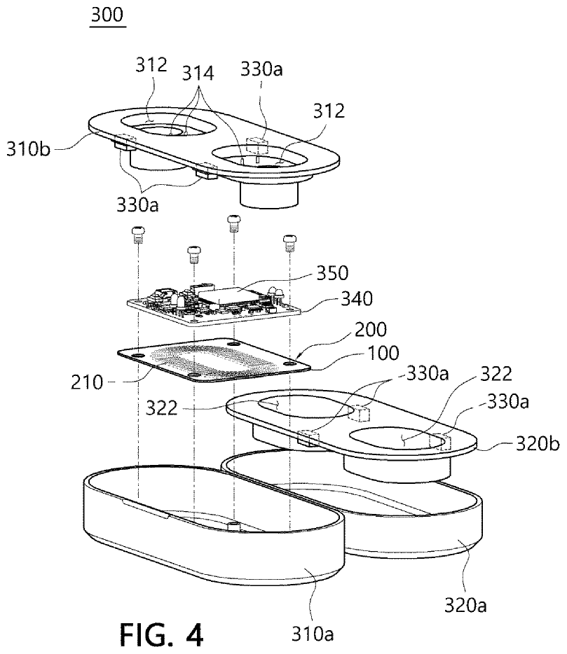

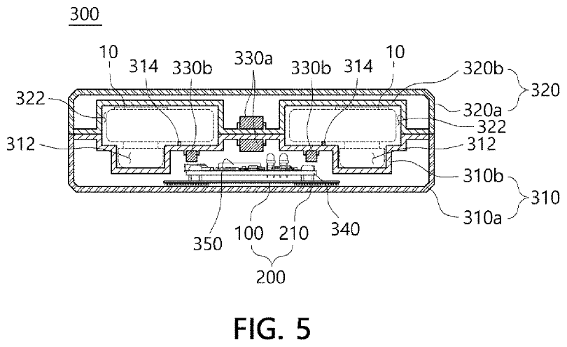

Accordingly, the magnetic shielding sheet 100 for a charging cradle according to one embodiment of the present invention may prevent performance degradation such as reduction of charging efficiency due to permanent magnets 330a and 330b (see FIG. 3) and may solve issues for quality certification by preventing the performance degradation such as the reduction of charging efficiency even when the permanent magnets 330a and 330b (see FIG. 3) are built in a charging cradle (see FIGS. 3 to 5) for charging a battery of a smartwatch or a battery of a wireless earphone. In this case, the quality certification may be Qi certification.

That is, in the magnetic shielding sheet 100 for a charging cradle according to one embodiment of the present invention, since the sheet body 110 is formed of the magnetic material having the saturation magnetic flux of 1.2 Tesla or more and the magnetic permeability of 400 or more, even when the permanent magnets 330a and 330b (see FIG. 3) are disposed at positions close to the sheet body 110, magnetic saturation due to a direct current magnetic field generated by the permanent magnets 330a and 330b (see FIG. 3) may be prevented in the sheet body 110.

Accordingly, since the magnetic shielding sheet 100 for a charging cradle according to one embodiment of the present invention satisfies an inductance required to smoothly operate the wireless power reception antenna 210, even when the permanent magnets are built in the charging cradle, an issue of certification such as Qi certification can be solved.

In addition, in the magnetic shielding sheet 100 for a charging cradle according to one embodiment of the present invention, since the sheet body 110 is formed of the magnetic material having the saturation magnetic flux of 1.2 Tesla or more and the magnetic permeability of 400 or more, the magnetic saturation of the sheet body 110 due to the direct current magnetic field can be prevented, and thus the sheet body 110 may have a very thin thickness.

As an example, the sheet body 110 may have an inductance required for operating the charging cradle normally even while having a thickness of 0.3 mm to 3 mm.

However, a total thickness of the sheet body 110 is not limited thereto and may be properly changed according to a required specification (a required inductance, an amount of power consumption, and the like).

In addition, the amorphous ribbon sheets 111a are illustrated as the magnetic material constituting the sheet body 110, but the present invention is not limited thereto, and a magnetic material having a saturation magnetic flux ranging from 1.2 Tesla to 2 Tesla and a magnetic permeability ranging from 400 to 5000 may be used without limitation.

Meanwhile, as illustrated in FIG. 1, the sheet body 110 may be formed separately into a plurality of pieces, and at least some adjacent pieces may be insulated from each other.

Accordingly, in the magnetic shielding sheet 100 for a charging cradle according to one embodiment of the present invention, flexibility of the sheet body 110 may be improved, and a total resistance of the sheet body 110 may be increased. Accordingly, in the magnetic shielding sheet 100 for a charging cradle according to one embodiment of the present invention, damage on the sheet body 110 due to an external force may be reduced, and an influence due to an eddy current may be minimized.

In this case, the sheet body 110 may have the magnetic permeability of 400 or more in a state in which the sheet body 110 is formed separately into the plurality of pieces. As a non-restrictive example, a magnetic permeability of the sheet body 110 may range from 600 to 1200 in a state in which the sheet body 110 is formed separately into a plurality of pieces.

In this case, as illustrated in an enlarged view of FIG. 1, the magnetic shielding sheet 100 for a charging cradle according to one embodiment of the present invention may further include one or more protective films 120 attached to at least one of an upper surface and a lower surface of the sheet body 110 through adhesive layers 122.

Accordingly, even when the sheet body 110 is formed separately into the plurality of pieces, the plurality of physically separated pieces from each other may be prevented from being separated to the outside through the protective film 120.

In addition, the sheet body 110 may be a multi-layer sheet in which a plurality of sheets are stacked through an adhesive layer.

As an example, the sheet body 110 may be the multi-layer sheet in which the plurality of sheets are stacked as two to thirty layers.

As a specific example, the sheet body 110 may be the amorphous ribbon sheets 111a including Fe, Si, and Nb, and the amorphous ribbon sheet 111a including the Fe, Si, and Nb may be formed separately into a plurality of pieces, and each of the pieces may be formed in an atypical shape.

In addition, the sheet body 110 may be a multi-layer sheet in which a plurality of amorphous ribbon sheets 111a separated into the plurality of pieces and including Fe, Si, and Nb are stacked in multiple layers through the adhesive layers 111b.

In this case, a magnetic permeability of each of the amorphous ribbon sheets 111a including Fe, Si, and Nb may be 400 or more in a state in which the amorphous ribbon sheet 111a is formed separately into the plurality of pieces, and the sheet body 110 may be the multi-layer sheet in which the amorphous ribbon sheets 111a including Fe, Si, and Nb are stacked as ten to thirty layers through the adhesive layers 111b.

As another example, the sheet body 110 may be the amorphous ribbon sheets 111a including Fe, Si, and B, and the amorphous ribbon sheet 111a including the Fe, Si, and B may be formed separately into a plurality of pieces, and each of the pieces may be formed in an atypical shape.

In addition, the sheet body 110 may be the multi-layer sheet in which the plurality of amorphous ribbon sheets 111a separated into the plurality of pieces and including Fe, Si, and B are stacked in multiple layer through the adhesive layers 111b.

In this case, a magnetic permeability of each of the amorphous ribbon sheets 111a including Fe, Si, and B may be 400 or more in a state in which the amorphous ribbon sheets 111a are formed separately into the plurality of pieces, and the sheet body 110 may be a multi-layer sheet in which the amorphous ribbon sheets 111a including Fe, Si, and B are stacked as two to ten layers through the adhesive layers 111b.

However, the total number of stacked layers of the amorphous ribbon sheets 111a constituting the sheet body 110 is not limited thereto and may be properly changed according to a specification and a power consumption capacity of a product.

Meanwhile, the amorphous ribbon sheet including Fe, Si, and B may have a saturation magnetic flux which is relatively higher than a saturation magnetic flux of the amorphous ribbon sheet including Fe, Si, and Nb. Accordingly, since the sheet body including the amorphous ribbon sheet including Fe, Si, and B may be implemented to have a thickness which is smaller than a thickness of the sheet body including the amorphous ribbon sheet including Fe, Si, and Nb, when the sheet body is composed of the amorphous ribbon sheet including Fe, Si, and B, the magnetic shielding sheet 100 for a charging cradle may be implemented with a thinner thickness.

Because of this reason, since the total number of the layers of the sheets constituting the sheet body 110 may decrease as the saturation magnetic flux of the magnetic material constituting the sheet body increases, a total thickness of the magnetic shielding sheet 100 for a charging cradle may decrease further.

Meanwhile, as described above, in a case in which the multi-layer sheet, in which the plurality of amorphous ribbon sheets 111a are stacked through the adhesive layers 111b, constitutes the sheet body 110, the adhesive layers 111b may include a nonconductive component. The adhesive layer 111b may be disposed between two amorphous ribbon sheets 111a stacked on each other, and some or all of the adhesive layer 111b may permeate two amorphous ribbon sheets 111a.

Accordingly, the pieces constituting the amorphous ribbon sheet 111a may be insulated due to the adhesive layer 111b including the nonconductive component permeating gaps between the pieces.

Here, the adhesive layer may be provided with a gel or liquid adhesive or may have a form in which a gel or liquid adhesive is applied on one or both surfaces of a film type base material.

Meanwhile, as illustrated in FIG. 2, the magnetic shielding sheet 100 for a charging cradle may be implemented in the wireless power reception module 200 for a charging cradle.

That is, the wireless power reception module 200 for a charging cradle may include the wireless power reception antenna 210 and the above-described magnetic shielding sheet 100 for a charging cradle.

Such a wireless power reception module 200 for a charging cradle may be employed in a charging cradle for charging a battery of a smartwatch or a battery of a wireless earphone like the above-described magnetic shielding sheet 100 for a charging cradle, and at least one of the permanent magnets 330a and 330b (see FIG. 3) may be built in the charging cradle.

The wireless power reception antenna 210 may receive wireless power supplied from an external device.

Such a wireless power reception antenna 210 may be a flat coil in which a conductive member having a predetermined length is wound a plurality of times and may be fixed to one surface of the magnetic shielding sheet 100 for a charging cradle through an adhesive layer (not shown).

Here, any known adhesive or gluing agent, such as a glue, polyvinyl chloride (PVC), rubber, or double-sided tape that has an adhesive property, may be used as the adhesive layer, and preferably, the adhesive layer may be an adhesive layer having thermal resistance.

In the present invention, the conductive member may be formed of a metal material having conductivity such as copper and the conductive member may be formed as one strip having a predetermined diameter or may be formed in a form in which a plurality of strips are twisted in a longitudinal direction.

In addition, the flat coil may be formed in a form in which the conductive member is wound the plurality of times in a clockwise direction or counterclockwise direction and may have any one of a circular shape, an oval shape, a polygonal shape, and a shape of a combination thereof.

However, the wireless power reception antenna 210 is not limited to the flat coil, and the wireless power reception antenna 210 may be formed as an antenna pattern formed on at least one surface of a circuit board.

In this case, as illustrated in FIG. 2, the magnetic shielding sheet 100 for a charging cradle may be disposed on one surface of the wireless power reception antenna 210 and may shield a magnetic field generated by the wireless power reception antenna 210.

Since contents of the magnetic shielding sheet 100 for a charging cradle are the same as the above-described contents thereof, the detailed description will be omitted.

Meanwhile, the above-described magnetic shielding sheet 100 for a charging cradle and the above-described wireless power reception module 200 for a charging cradle may be employed in the charging cradle for charging a battery of a smartwatch or a battery of a wireless earphone.

As a non-restrictive example, as illustrated in FIGS. 3 to 5, the above-described magnetic shielding sheet 100 for a charging cradle and the above-described wireless power reception module 200 for a charging cradle may be employed in a charging cradle 300 for a wireless earphone for charging a wireless earphone 10. Here, the wireless earphone 10 may be a Bluetooth earphone.

Specifically, the charging cradle 300 for a wireless earphone may include a case 310, a cover 320, the permanent magnets 330a and 330b, a circuit board 340, the magnetic shielding sheet 100, the wireless power reception antenna 210, and a battery 350.

Here, since contents of the magnetic shielding sheet 100 and the wireless power reception antenna 210 constituting the charging cradle 300 for a wireless earphone are the same as the above-described contents thereof, the detailed descriptions will be omitted.

The circuit board 340, the magnetic shielding sheet 100, the wireless power reception antenna 210, the battery 350, and the like may be installed in the case 310, and the case 310 may include at least one first accommodation part 312 for accommodating the wireless earphone 10.

Although the case 310 may be formed as one member, the case 310 may include an outer case 310a and an inner case 310b.

As an example, the outer case 310a may be formed in a box shape having an open upper portion, and the wireless power reception antenna 210, the magnetic shielding sheet 100, the circuit board 340, and the battery 350 may be sequentially disposed inside the outer case.

In this case, the inner case 310b may be coupled to the outer case 310a to be positioned above the battery 350.

In this case, the wireless power reception antenna 210 may be disposed to directly face a bottom surface of the outer case 310a in order to smoothly receive the wireless power supplied from an external device.

Accordingly, the wireless power received through the wireless power reception antenna 210 may be supplied to the battery 350, and power of the battery 350 may be charged with the wireless power.

Here, the circuit board 340 may control overall operations. That is, a driving chip such as a main control unit (MCU) for controlling the overall operations may be mounted on one surface of the circuit board 340.

In addition, the circuit board 340 may include a charging circuit and the like to drive the wireless power reception antenna 210 and supply the power received through the wireless power reception antenna 210 to the battery 350.

Meanwhile, at least one first accommodation part 312 for accommodating the wireless earphone 10 may be formed in the inner case 310b.

In addition, at least one charging terminal 314 electrically connected to the wireless earphone 10 may be provided on the first accommodation part 312.

Accordingly, when the wireless earphone 10 is inserted into the first accommodation part 312, the at least one charging terminal 314 may be in contact with a contact terminal (not shown) of the wireless earphone 10.

Accordingly, the power stored in the battery 350 may be supplied to the wireless earphone 10 through the charging terminal 314, and the battery of the wireless earphone 10 may be charged with the power provided from the battery 350.

The cover 320 may be coupled to the case 310 to cover an open upper portion of the first accommodation part 312.

Although the cover 320 may be formed as one member, the cover 320 may include an outer cover 320a and an inner cover 320b.

In addition, the cover 320 may include a second accommodation part 322 for accommodating a part of the wireless earphone 10 inserted into the first accommodation part 312.

As an example, the outer cover 320a may be formed in a box shape having an open one side, and the second accommodation part 322 for accommodating a part of the wireless earphone 10 may be formed in the inner cover 320b.

Here, the second accommodation part 322 may be formed at a position corresponding to the first accommodation part 312 formed in the case 310.

Accordingly, when the cover 320 covers the open upper portion of the first accommodation part 312, the wireless earphone 10 may be accommodated and stored in the first accommodation part 312 and the second accommodation part 322 and may be prevented from being exposed to the outside.

In this case, the charging cradle 300 for a wireless earphone according to one embodiment of the present invention may include at least one of permanent magnets 330a and 330b. Such permanent magnets 330a and 330b may provide magnetic forces for maintaining coupling between the cover 320 and the case 310 or for fixing a position of the wireless earphone 10 inserted into the first accommodation part 312.

Accordingly, since the position of the wireless earphone 10 is fixed due to the magnetic force provided by the permanent magnet in a state in which the wireless earphone 10 is stored in the charging cradle 300, a state in which the charging terminal 314 provided on the first accommodation part 312 is in contact with the contact terminal (not shown) of the wireless earphone 10 is maintained, and thus the wireless earphone 10 may be smoothly charged.

As an example, the permanent magnets 330a and 330b may include first permanent magnets 330a for maintaining coupling between the cover 320 and the case 310 and second permanent magnets 330b for fixing the position of the wireless earphone 10 inserted into the first accommodation part 312.

Here, the first permanent magnet 330a may be provided on each of the cover 320 and the case 310, and the first permanent magnet 330a provided on the cover 320 and the first permanent magnet 330a provided on the case 310 may be provided at the corresponding positions. As a non-restrictive example, the first permanent magnet 330a may be provided on each of the inner cover 320b and the inner case 310b.

In addition, the second permanent magnet 330b may be provided to be positioned under the first accommodation part 312 in the inner case 310b.

Accordingly, when the wireless earphone 10 is inserted into the first accommodation part 312, the position of the wireless earphone 10 is fixed by the magnetic force, and thus a state in which charging terminal 314 is in contact with the contact terminal of the wireless earphone 10 may be maintained.

Accordingly, since the wireless earphone 10 may smoothly receive the power for charging through the contact terminal, the battery of the wireless earphone 10 can be smoothly charged.

As described above, when the permanent magnets 330a and 330b are employed in the charging cradle 300 for charging power of the wireless earphone 10, a direct current magnetic field generated by the permanent magnets 330a and 330b may affect the performance of the magnetic shielding sheet 100.

However, in the present invention, as the above-described, since the magnetic material having the saturation magnetic flux of 1.2 Tesla or more and the magnetic permeability of 400 or more is used as a material of the sheet body 110 constituting the magnetic shielding sheet 100 for a charging cradle, influence of the direct current magnetic field generated by the permanent magnets 330a and 330b can be minimized.

That is, when the magnetic shielding sheet 100 for a charging cradle according to one embodiment of the present invention is employed, performance degradation such as reduction of wireless charging efficiency due to the direct current magnetic field can be prevented, and issues for quality certification such as Qi certification may be solved together through the prevention from the performance degradation.

In other words, since the magnetic shielding sheet 100 used in the charging cradle 300 for a wireless earphone has properties of the saturation magnetic flux of 1.2 Tesla or more and the magnetic permeability of 400 or more, even when the permanent magnets 330a and 330b are disposed at the positions close to the magnetic shielding sheet 100, the magnetic saturation due to the direct current magnetic field generated by the permanent magnets 330a and 330b may be prevented in the magnetic shielding sheet 100.

Accordingly, the magnetic shielding sheet 100 used in the charging cradle 300 for a wireless earphone can satisfy an inductance required to smoothly operate the wireless power reception antenna 210, and issues for certification such as Qi certification can be solved.

While the embodiments of the present invention have been described above, the spirit of the present invention is not limited to the embodiments proposed in this specification, and the other embodiments may be easily suggested by adding, changing and the deleting components by those skilled in the art and will fall within the spiritual range of the present invention.

1. A magnetic shielding sheet for a charging cradle in which at least one permanent magnet is built, the magnetic shielding sheet comprising a sheet body formed of a magnetic material to shield a magnetic field,
wherein the sheet body is formed of a magnetic material having a saturation magnetic flux of 1.2 Tesla or more.

2. The magnetic shielding sheet of claim 1, wherein the sheet body is a heat-treated amorphous ribbon sheet.

3. The magnetic shielding sheet of claim 2, wherein the amorphous ribbon sheet is a ribbon sheet including Fe, Si, and B and is a multi-layer sheet stacked as two layers to ten layers.

4. The magnetic shielding sheet of claim 2, wherein the amorphous ribbon sheet is a ribbon sheet including Fe, Si, and Nb and is a multi-layer sheet stacked as ten layers to thirty layers.

5. The magnetic shielding sheet of claim 2, wherein:
the amorphous ribbon sheet is formed separately into a plurality of pieces; and
the amorphous ribbon sheet has a magnetic permeability of 400 or more in a state in which the amorphous ribbon sheet is formed separately into the plurality of pieces.

6. The magnetic shielding sheet of claim 1, wherein the sheet body has a magnetic permeability ranging from 600 to 1200.

7. A wireless power reception module for a charging cradle, which is applied to a charging cradle in which at least one permanent magnet is built, the wireless power reception module comprising:
a wireless power reception antenna configured to receive wireless power; and
a magnetic shielding sheet disposed on one surface of the wireless power reception antenna to shield a magnetic field,
wherein the magnetic shielding sheet is the magnetic shielding sheet for a charging cradle of claim 1.

8. The wireless power reception module of claim 7, wherein the wireless power reception antenna is a flat coil in which a conductive member having a predetermined diameter is wound in one direction.

9. A charging cradle for a wireless earphone, comprising:
a case in which an accommodation part for accommodating a wireless earphone is formed;
a cover coupled to the case to cover an open upper portion of the accommodation part;
at least one permanent magnet provided on at least any one side of the case and the cover;
a circuit board which is built in the case and is configured to control an overall operation;
a magnetic shielding sheet disposed under the circuit board to shield a magnetic field; and
a wireless power reception antenna disposed on one surface of the magnetic shielding sheet to receive wireless power,
wherein the magnetic shielding sheet is the magnetic shielding sheet for a charging cradle of claim 1.

10. The wireless power reception module of claim 7, wherein the sheet body is a heat-treated amorphous ribbon sheet.

11. The wireless power reception module of claim 10, wherein the amorphous ribbon sheet is a ribbon sheet including Fe, Si, and B and is a multi-layer sheet stacked as two layers to ten layers.

12. The wireless power reception module of claim 10, wherein the amorphous ribbon sheet is a ribbon sheet including Fe, Si, and Nb and is a multi-layer sheet stacked as ten layers to thirty layers.

13. The wireless power reception module of claim 10, wherein:
the amorphous ribbon sheet is formed separately into a plurality of pieces; and
the amorphous ribbon sheet has a magnetic permeability of 400 or more in a state in which the amorphous ribbon sheet is formed separately into the plurality of pieces.

14. The wireless power reception module of claim 7, wherein the sheet body has a magnetic permeability ranging from 600 to 1200.

15. The charging cradle of claim 9, wherein the sheet body is a heat-treated amorphous ribbon sheet.

16. The charging cradle of claim 15, wherein the amorphous ribbon sheet is a ribbon sheet including Fe, Si, and B and is a multi-layer sheet stacked as two layers to ten layers.

17. The charging cradle of claim 15, wherein the amorphous ribbon sheet is a ribbon sheet including Fe, Si, and Nb and is a multi-layer sheet stacked as ten layers to thirty layers.

18. The charging cradle of claim 15, wherein:
the amorphous ribbon sheet is formed separately into a plurality of pieces; and
the amorphous ribbon sheet has a magnetic permeability of 400 or more in a state in which the amorphous ribbon sheet is formed separately into the plurality of pieces.

19. The charging cradle of claim 9, wherein the sheet body has a magnetic permeability ranging from 600 to 1200.
